(19) United States
(12) Patent Application Publication
(10) Pub. No.: US 2025/0293812 A1
(43) Pub. Date: Sep. 18, 2025

(54) Satellite-Based HARQ Handling in Communication with Terrestrial User Equipment

(71) Applicant: Lynk Global, Inc., Falls Church, VA (US)

(72) Inventors: Tomohiro Arakawa, Alexandria, VA (US); Marc Alaric Georges Lamothe, Falls Church, VA (US); Tyghe Robert Speidel, Washington, DC (US)

(21) Appl. No.: 19/078,076

(22) Filed: Mar. 12, 2025

Related U.S. Application Data
(60) Provisional application No. 63/564,078, filed on Mar. 12, 2024.

(51) Int. Cl. H04L 1/1812; H04L 1/00; H04L 5/00

(52) U.S. Cl. CPC H04L 1/1812; H04L 1/0038; H04L 5/0053

(57) ABSTRACT

A method of communication over a cellular network connection between a mobile device and a base station is provided, wherein the mobile device and the base station are configured to operate according to a protocol, wherein the protocol has a design assumption of a maximum distance between communicating devices, and wherein the mobile device and the base station are separated by more than the maximum distance. The method might comprise receiving uplink data at the base station, decoding the uplink data, and prior to determining whether the uplinked data is correctly received at the base station, transmitting a feedback acknowledgement message to the mobile device, determining whether the uplinked data is correctly received at the base station, and if not, recording a need for retransmission, and transmitting to the mobile device a feedback message for a subsequent data unit, wherein the feedback message indicates failure of the uplink data unit.

### CROSS-REFERENCES TO PRIORITY AND RELATED APPLICATIONS

This application is a non-provisional of, and claims the benefit of and priority from, U.S. Provisional Patent Application No. 63/564,078 filed Mar. 12, 2024, entitled “Satellite-Based HARQ Handling in Communication with Terrestrial User Equipment”. The entire disclosure of the application recited above is hereby incorporated by reference, as if set forth in full in this document, for all purposes.

### FIELD

The present disclosure generally relates to satellite-terrestrial communications and more particularly to handling communications according to particular protocols when signal propagation delays exceed design assumptions of the particular protocols, such as when an orbital base station communicates with a terrestrial user equipment (UE).

### BACKGROUND

Mobile communication devices, and more generally, user equipment (UE), communicate with one or more base stations to allow data/voice/video/text/etc. to flow between the UE and remote systems, such as Internet-connected servers, equipment, other user equipment, etc. The communication follows a particular protocol or protocols so that a UE expects, is programmed for, and/or is configured so that the UE can communicate with a base station. Many wireless communication protocols have been implemented and have become standards such that devices programmed and configured to operate consistent with a given protocol can communicate. Examples of standard protocols include the Global System for Mobile Communications (GSM) protocol, the Universal Mobile Telecommunications Service (UMTS) protocol, the Long-Term Evolution (LTE) protocol, and the 5G protocol. These protocols might be defined by standardization bodies such as the 3rd Generation Partnership Project (3GPP). The wireless communication protocols can provide reliable wireless connectivity to the mobile devices, typically under certain design assumptions. The description herein might apply to other wireless communication protocols and standards not specifically called out.

A given protocol might have been developed with certain design assumptions. For example, a protocol might assume a maximum length of a text message, a particular format for a telephone number, that a base station is stationary, that a UE is travelling at less than some maximum speed relative to the ground (e.g., the surface of the Earth) and relative to the base station, that the distance between the base station and the UE is less than a maximum design distance, etc.

A base station might be a terrestrial cellular telephone tower that is configured and/or programmed to communicate according to a particular protocol. An example might be a base station that might be referred to herein as an “eNB” that is an “ENodeB” or “E-UTRAN Node B”, which is short for “Evolved Node B” that includes hardware, software, and/or firmware of a base station that communicates using the LTE protocol. The description herein might apply to other protocols besides LTE, which is used here as an example.

A protocol might take into account that signals sent are not guaranteed to be received correctly as sent and thus might specify how a device is to convey to another device that signals/data/etc. are received correctly, not received, or received but with errors. For example, a protocol might specify how a device sends an acknowledgement of successful receipt of a packet or other unit of data (an “ACK”), a message indicating failed receipt of a packet or other unit of data (a “NACK”), a request for repeat transmission of a unit of data (“ARQ”), and various other handshaking, error recovery, confirmation, and control messaging. In many cases, a protocol specifies messaging and interpretation of data and signals using a network layer approach, such as the Open Systems Interconnection (OSI) model's seven-layer networking convention.

As one example, the LTE protocol defines a hybrid ARQ (HARQ) protocol as part of its medium access control (MAC) layer. The HARQ procedure combines error correction and detection capabilities of a decoder with retransmission based on automatic repeat requests (ARQs). The HARQ protocol is beneficial for recovering data that has errors due to noise, interference, and various other impairments present in the physical layer. The LTE protocol specifies multiple HARQ processes on uplink communications and downlink communications for efficient data transfer, and each HARQ process is responsible for transferring one MAC protocol data unit (PDU) at a time. For compatibility, each base station and UE that are communicating using the LTE protocol should implement the required portions of LTE including the required portions of the LTE HARQ protocol.

The uplink and downlink channels of LTE employ synchronous and asynchronous HARQ, respectively. The synchronous HARQ for the uplink channel synchronizes HARQ processes between a UE and an eNB based on a current transmission time interval (TTI) without explicit exchange of the identification of HARQ processes. The HARQ processes are interleaved sequentially and data and HARQ are exchanged periodically with, or over, a predetermined time interval. In contrast, asynchronous HARQ for LTE downlink explicitly exchanges identifications of HARQ processes, allowing the downlink data to be transferred in a non-periodic or sequential manner.

The synchronous HARQ for uplink data transfer has two operating modes, namely adaptive and non-adaptive HARQ. With the adaptive HARQ mode, retransmission of uplink data is performed by sending negative acknowledgment (NACK) on the physical hybrid ARQ indicator channel (PHICH) along with an uplink grant, also known as DCI 0, containing new uplink scheduling information on the physical downlink control channel (PDCCH). A DCI 0 uplink grant for the LTE frequency-division duplex mode in 3GPP Release 9 might contain the fields shown in Table 1.

TABLE 1
DCI 0 Uplink Grant Fields

| Field | Description |
|---|---|
| Format Type Flag (e.g., for | Type of DCI (Downlink Control |
| differentiation of format0, | Information) message |
| format1A, etc.) | |
| Frequency hopping flag | Indicates if frequency hopping |
| | needs to be performed |
| Resource block assignment | Uplink resource allocation |
| Modulation and coding scheme and | Uplink modulation, coding scheme, |
| redundancy version | and redundancy version for HARQ |
| New Data Indicator (NDI) | Indicates whether new data needs |
| | to be transmitted |
| TPC (Transmit Power Control) | Uplink transmit power control |
| command for scheduled PUSCH | information |
| (Physical Uplink Shared Channel) | |
| Cyclic shift for DMRS | Uplink demodulation reference |
| (Demodulation Reference Signal) | signal information |
| and OCC (Orthogonal Cover | |
| Code) index | |
| CQI (Channel Quality Indicator) | Indicates whether channel quality |
| Request | information needs to be transmitted |

In DCI 0, the uplink grant contains a one-bit field named New Data Indicator (NDI), which is read by UE to determine whether new data needs to be sent in a next transmission opportunity. A non-toggled NDI (i.e., the same NDI as the one for the last transmission) indicates retransmission of the last PDU while a toggled NDI (i.e., different NDI from the last transmission) indicates transmission of a new PDU. In the case of non-adaptive HARQ, the HARQ feedback is sent on the PHICH without an uplink grant. Sending a NACK on the PHICH triggers the retransmission of the previously sent data in the next uplink opportunity without explicit scheduling information from the eNB. Positive acknowledgment (ACK) feedback on the PHICH does not automatically trigger the UE to perform transmission of the new PDU. Instead, the UE pauses the corresponding HARQ process until it receives an uplink grant with new scheduling information. See, for example, [Dahlman].

The HARQ protocol of LTE operates with the round-trip time (RTT) between the sender and receiver being 3 milliseconds or less and has problems if the RTT is greater than some value around 3 milliseconds. There are eight HARQ processes in the LTE uplink channel, and the LTE uplink channel alternately handles data transfer and feedback transfer every four TTIs. This means that the UE expects, per the protocol in use, to receive HARQ feedback in exactly 4 milliseconds after the last uplink transmission. This timing requirement cannot be met if the round-trip propagation delay is larger than 3 milliseconds with 1 millisecond allotted for decoding time (4 milliseconds less whatever decoding time is needed). The base station might need to decode a full PDU before it can transmit a HARQ feedback message (i.e., the base station cannot receive a PDU and transmit feedback simultaneously in the same TTI). Thus, the maximum allowable round-trip propagation delay might be reduced by 1 millisecond, accounting for the decoding time at the base station, from the original HARQ feedback delay requirement of 4 milliseconds.

In other words, a design assumption of the LTE protocol is that the round-trip propagation delay is 3 milliseconds or less, and due to the finite speed of light, this corresponds to a design assumption that the UE and the eNB will be within 450 km of each other (which is a one-way delay of 1.5 milliseconds or less) when operating and communicating. This might be an acceptable constraint if the UE and the base station are both on the ground and there is a base station within 450 km of each UE needing service. This might not be workable where the base station is in orbit, as many satellites must operate at altitudes higher than 450 km and/or might be further away than 450 km when communicating. Therefore, the timing requirement of synchronous HARQ becomes a major challenge in order to run an eNB as a satellite payload.

[Sutton] describes one approach to addressing extended time delay using the HARQ LTE procedure with orbital distances/delays. In that approach, blind ACK messages are sent to the device and then messages are aggregated from the MAC layer up to the Radio Link Control (RLC) layer. If there is no decoded message, then the device is NACKed at the RLC layer. This is potentially useful in situations where the signal to noise ratio (SNR) is high and error probability is low, but this is not very useful, or efficient, when SNR is low since retransmission on the RLC layer occurs at a lower rate than the HARQ protocol on the MAC layer. Supporting satellite-based communications to standard unmodified handsets requires overcoming substantial path loss (more than a typical terrestrial system might have) and will certainly need to contend with situations where SNRs are low (particularly at a cell/beam/footprint edge).

[Katzav] describes a method to deliver HARQ feedback to a UE in a non-terrestrial communication scenario by sending feedback based on the predicted channel characteristics. While this might find use where the channel conditions do not change rapidly, this may significantly increase the latency of the communication link when accurate prediction of channel quality cannot be made. Satellite communication systems, especially those employing low-earth orbit satellites, often encounter rapid change in channel conditions attributable to the high velocities inherent in their operation and other conditions.

### REFERENCES

[Dahlman] Erik Dahlman, et al., “4G LTE-Advanced Pro and The Road to 5G,” Academic Press (2016).
[Katzav]U.S. Pre-Grant Publication 2022/0038988 A1, published Feb. 3, 2022, naming Katzav.
[Sutton]U.S. Pat. No. 10,841,890 B2 issued Nov. 17, 2020, naming Sutton et al.

### SUMMARY

A communication system can operate LTE E-UTRAN over a channel with a propagation delay that exceeds the standard round-trip requirements of synchronous HARQ. This can be implemented without requiring changes to handsets with LTE support, although some details might be implemented with allowable LTE modifications. This method can be used in non-terrestrial cellular deployment scenarios, including a satellite-direct-to-phone architecture where the satellite running eNB directly communicates with UE on ground (or a regenerative payload). This method can also carry relevance to satellite-direct-to-phone architectures where a ground station is communicating with a UE on the ground through a satellite bent-pipe implementation (or a non-regenerative payload).

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of methods and apparatus, as defined in the claims, is provided in the following written description of various embodiments of the disclosure and illustrated in the accompanying drawings.

### BRIEF DESCRIPTION OF THE DRAWINGS

Various embodiments in accordance with the present disclosure will be described with reference to the drawings, in which:

FIG. 1 illustrates an HARQ operation scenario in standard terrestrial networks without excessive delay.

FIG. 2 illustrates an HARQ operation scenario with excessive propagation delay.

FIG. 3 illustrates an HARQ operation scenario using a blind NACK, according to various embodiments.

FIG. 4 illustrates an HARQ operation scenario using a blind ACK, according to various embodiments.

FIG. 5 illustrates an HARQ operation scenario using two HARQ processes, according to various embodiments.

FIG. 6 illustrates a TTI bundling operation scenario in standard terrestrial networks without excessive propagation delay, according to various embodiments.

FIG. 7 illustrates a TTI bundling operation scenario in standard terrestrial networks without excessive propagation delay and four active HARQ processes, according to various embodiments.

FIG. 8 illustrates a TTI bundling operation scenario failing to operate where there is excessive propagation delay, according to various embodiments.

FIG. 9 illustrates a TTI bundling operation scenario modified to operate even with excessive propagation delay, according to various embodiments.

FIG. 10 illustrates a TTI bundling operation scenario modified to operate even with excessive propagation delay, according to various embodiments.

FIG. 11 illustrates a communications environment wherein UEs communicate with terrestrial base stations and orbital base stations and can do so without requiring reconfiguration of the UEs.

FIG. 12 illustrates how messages and data can be conveyed from one UE to another via orbital base stations, in compliance with one or more protocols.

FIG. 13 is a block diagram of some elements that might be present in a satellite housing an orbital base station.

FIG. 14 illustrates how users using UEs, such as mobile phones, smart devices, computers, etc. can connect to network resources via an orbital base station.

FIG. 15 illustrates an example computer system memory structure as might be used in performing methods described herein, according to various embodiments.

FIG. 16 is a block diagram illustrating an example computer system upon which the systems illustrated in FIGS. 1 and 15 may be implemented, according to various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

As described in the background, a HARQ process, which is part of a MAC layer protocol of LTE, performs retransmission and error correction of corrupted data passed from the lower layer of the protocol stack. An uplink channel in 4G LTE employs synchronous HARQ and the UE expects receive HARQ feedback in 4 milliseconds, or TTIs, after the uplink data is transmitted. Assuming that the processing delay is zero, the protocol allows three TTIs for propagating the uplink message to the network and receiving the feedback.

Supporting satellite-based communications to standard unmodified handsets requires overcoming substantial path loss (more than a typical terrestrial system might have) and should operate in situations where SNRs are low (particularly at cell/beam/footprint edges). As explained herein, a satellite-based communications system can handle failed packet decode events at network layer 2, so that failed packets can be reconciled prior to network layer 3. This can radically reduce repeated packet transmissions in the call flows, particularly in conditions with low SNR.

Improvements are described herein that allow HARQ to operate in a deterministic manner without requiring prediction of channel conditions. In various figures, transmission time intervals specified by the protocol in use are shown by sequentially-numbered boxes and messages transmitted between a UE and an eNB are illustrated with labelled arrows. For example, an arrow labelled “UL Grant” might represent a transmission of an upload grant message. In some figures, a transmission delay is represented by an offset of the sequentially-numbered boxes as between the UE and the eNB.

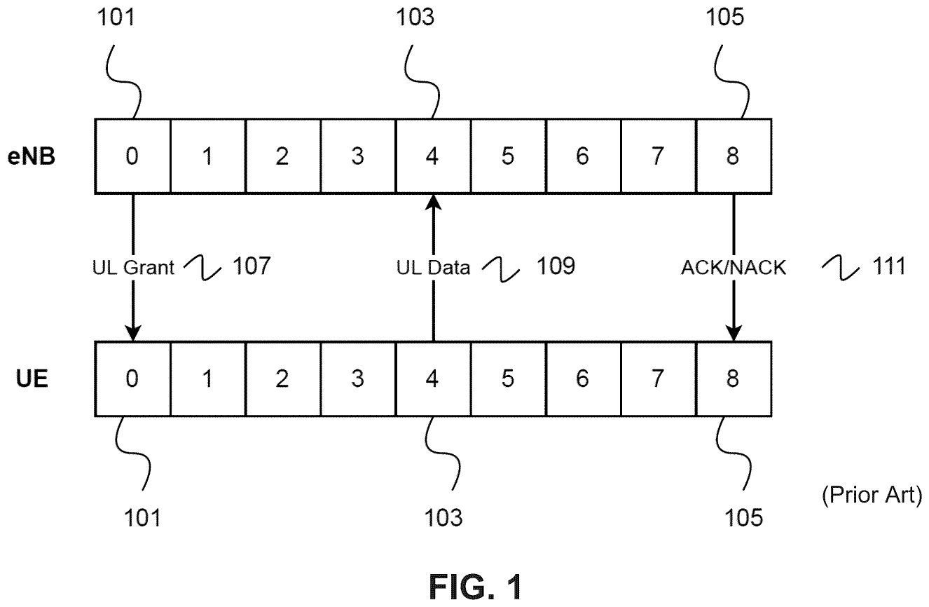

FIG. 1 shows a typical HARQ operation in a terrestrial scenario. The eNB schedules resources for uplink (UL) transmission such as physical resource blocks (PRBs) and notifies the UE of a scheduling result using an uplink grant 107. Assuming that an eNB sends uplink grant 107 in TTI #0 101, the UE transmits a PDU 109 containing uplink data in TTI #4 103, and thus the UE expects to receive an HARQ feedback message 111 in TTI #8 105. The HARQ feedback message 111 contains information about whether the base station has decoded the uplink data successfully, based on integrity check procedures such as a cyclic redundancy check (CRC). If an ACK feedback message is received, the UE can conclude that the last uplink was successful and completes the transmission of the PDU. If a NACK feedback message is received, the UE performs retransmission of the last PDU 109, four TTIs after the TTI 105 in which the NACK message was received.

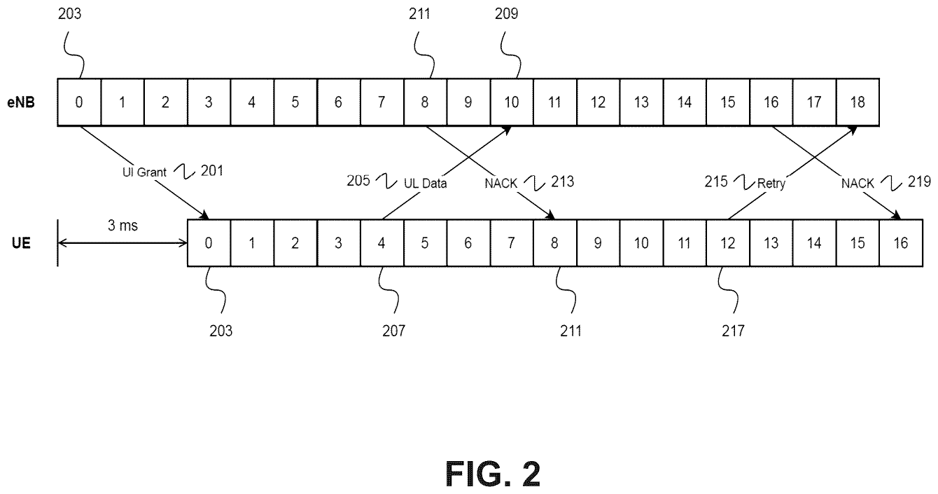

FIG. 2 shows how the HARQ protocol fails to operate over a long propagation delay between eNB and UE. In this example, a 3-millisecond one-way propagation delay is assumed. The eNB schedules resources for UL transmission and sends an uplink grant, 201, in TTI #0, 203. The UE transmits uplink data, 205, in TTI #4, 207, which arrives in TTI #10, 209, at eNB due to the propagation delay. For the UE to receive HARQ feedback four TTIs after the uplink transmission, the eNB must transmit a feedback message in TTI #8 211. In FIG. 2, TTI #8 211 comes before the UL data 205 from UE arrives. Thus, the timing requirement of HARQ operation cannot be met in this scenario, and the eNB sends a NACK, 213 in TTI #8, 211. After receiving the NACK, the UE sends a retry UL data, 215, in TTI #12, 217. This process results in another NACK, 219, due to the propagation delay issue, and failure continues to repeat in this scenario.

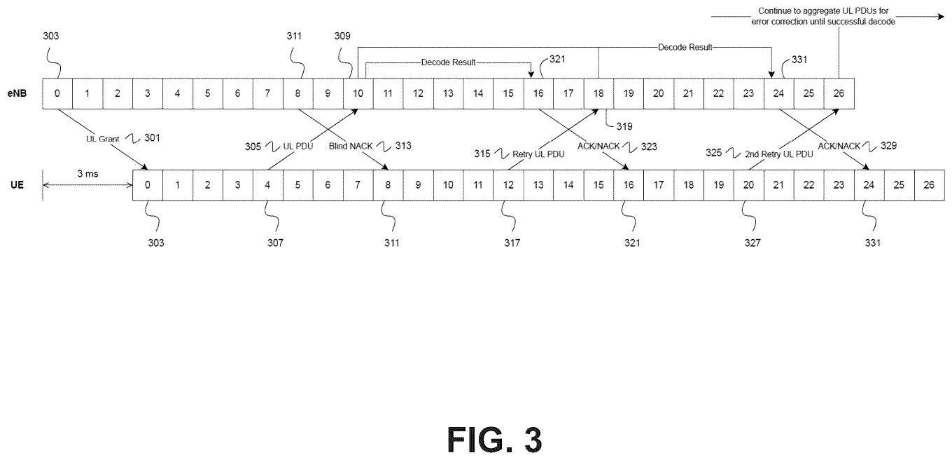

FIG. 3 illustrates how an excessive propagation delay is handled by sending blind NACKs to a UE using the methods and apparatus described herein. In this method, an eNB proactively sends a blind NACK message 313 before decoding an uplink message. After an uplink (UL) grant 301 in TTI #0 303, the UE sends a UL PDU 305 in TTI #4 307. Since the uplink transmission is scheduled by the eNB in advance, the same scheduling information can be used to determine when an HARQ feedback message needs to be sent to UE without decoding the PDU. The eNB knows that the burst of UL PDU 305 will arrive in TTI #10 309. Since this is after it needs to provide HARQ feedback in TTI #8 311, the eNB sends a blind NACK 313 in TTI #8. Sending blind NACK 313 forces the UE to retransmit uplink data as Retry UL PDU 315 and waits for a HARQ feedback message from the eNB. In the meantime, the eNB uses the decoding result of UL PDU 305 received in TTI #10 309 to determine a HARQ feedback message 323 for Retry UL PDU 315 received in TTI #18 319. Specifically, if UL PDU 305 is successfully decoded, the eNB sends an ACK as HARQ feedback message 323 in TTI #16 321 in response to Retry UL PDU 315. Otherwise, the eNB sends a NACK as HARQ feedback message 323 and generates a later HARQ feedback message 329 for the uplink transmission using the decoding result of the two uplink transmissions, UL PDU 305 and Retry UL PDU 315. This process might be repeated until the uplink transmission is successfully decoded or the maximum number of retransmission attempts defined by the protocol is reached. This might be done using a second Retry UL PDU 325 in TTI #20 327 and a HARQ feedback message 329 from TTI #24 331.

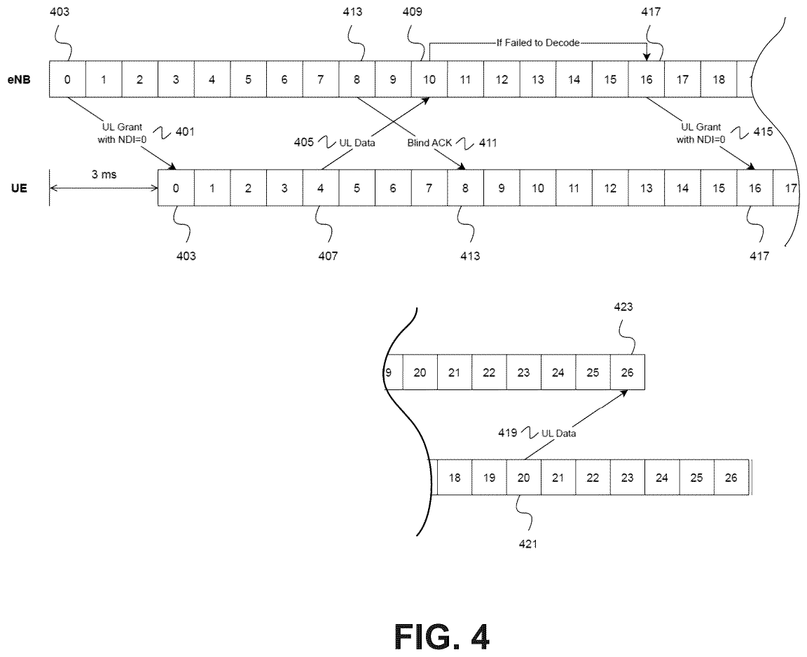

FIG. 4 illustrates handling an excessive propagation delay using an uplink grant in combination with HARQ feedback sent on the PHICH. In this method, the eNB sends a blind ACK 411 in TTI #8 413 before receiving the data in TTI #10 409 and uses an uplink grant 415 in TTI #16 417 to perform retransmission. After an uplink grant 401 with NDI=0 in TTI #0 403, the UE transmits uplink data 405 in TTI #4 407, which arrives in TTI #10 409 at eNB. Since the UE expects to receive HARQ feedback in TTI #8 413, the eNB sends a blind ACK 411 in TTI #8 413 on the PHICH. The eNB receives uplink data 405 in TTI #10 409, and it completes the HARQ operation if the data is successfully decoded. In this case, no further interactions between eNB and UE are required since blind ACK 411 would have already been sent to UE in TTI #10 413. If the uplink PDU (uplink data 405) is not decoded successfully, the eNB sends an uplink grant 415 without toggling the NDI (i.e., the same value as in the initial uplink grant) in TTI #16 417, triggering retransmission of the uplink data. Note that the method based on a blind ACK requires a smaller number of data transmissions between eNB and UE to complete uplink data transfer compared to a method based on a blind NACK. This has an effect of improving the overall system efficiency, such as total data throughput of eNB.

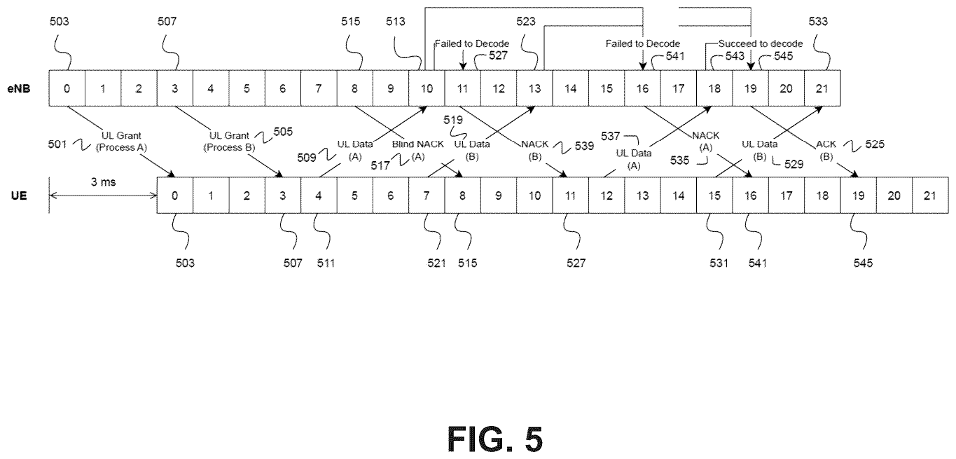

FIG. 5 illustrates a method and apparatus of reducing latency. The latency of uplink transmission can be reduced in a system where duplicate PDUs can be simultaneously transmitted on multiple HARQ processes. In this scenario, two HARQ processes, namely HARQ Processes A and B, are used between eNB and UE. A first UL grant 501 for HARQ Process A is issued to the UE in TTI #0 503 to start the uplink data transfer. Three TTIs later, the eNB proactively sends a second UL grant 505, corresponding to HARQ Process B, in TTI #3 507 to request transmission of the identical PDU requested in the first UL grant 501. The UE transmits a first UL PDU 509 for HARQ Process A and the data arrives at eNB in TTI #10 513. Since the UE needs to receive feedback for HARQ Process A in TTI #8 515, a blind NACK message 517 is issued from the eNB in TTI #8 515. HARQ Process B transmits a second UL PDU 519 in TTI #7 521, which arrives at eNB in TTI #13 523. The eNB uses the decoding result of the first uplink PDU 509 to generate HARQ feedback for HARQ Process B using the knowledge that two uplink PDUs are identical. If the first UL PDU 509 was not successfully decoded by the eNB, NACK feedback 539 is sent to the UE in TTI #11 527, which triggers a UL PDU retransmission 529 in TTI #15 531. Similarly, the eNB combines the uplink PDUs, first UL PDU 509 and second UL PDU 519, to generate HARQ feedback sent in TTI #16 541. If decoding fails, NACK feedback 535 for HARQ Process A is sent to the UE. The feedback for a next UL PDU 529 is generated based on the decoding result of combining the previous three uplink PDUs, first UL PDU 509, second UL PDU 519, and a third UL PDU 537. Assuming the combined PDU is successfully decoded, an ACK message 525 is sent to the UE. As shown in FIG. 5 and explained herein, employing multiple HARQ processes allows the eNB to generate HARQ based on decoding results of other HARQ processes, reducing an overall latency of uplink transmission. While the LTE protocol might not support requests that a UE send duplicate PDUs using two or more HARQ processes, this feature can be added to reduce latency in a low-SNR, high error rate environment.

TTI bundling can be used to reduce latency by transmitting more than one uplink TTIs without waiting for HARQ feedback. In some approaches, four duplicates of the channel-coded transport block are generated, and each duplicate can be processed using a different Redundancy Version (RV). The four duplicates can be mapped onto four consecutive uplink TTIs. Each bundle of four TTI requires a single resource allocation from the eNB and a single HARQ feedback message. The timing of the HARQ has for reference the last TTI within the bundle and the acknowledgement is sent four TTIs after.

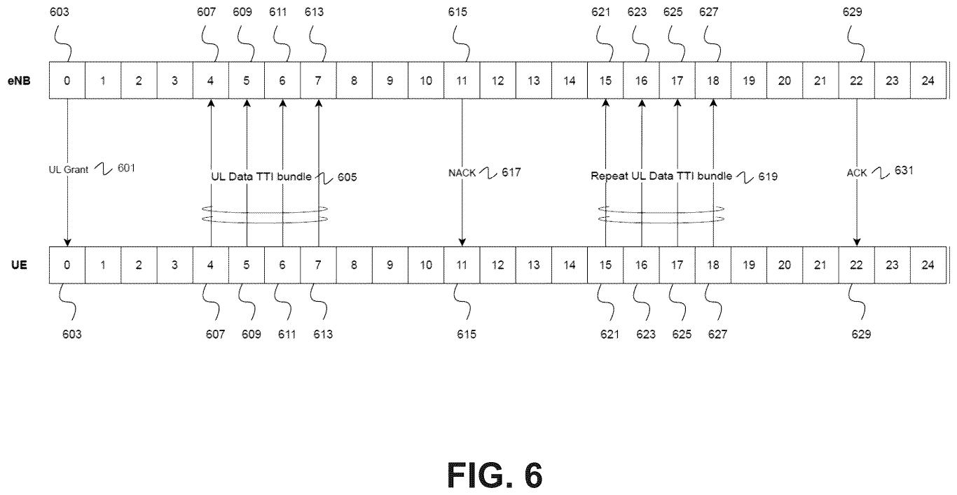

FIG. 6 shows a TTI bundling operations in a terrestrial scenario. In the case of FDD, the eNB sends to the UE an uplink grant (DCI 0) 601 to schedule resources for UL TTI bundling transmission on TTI #0 603. Four TTIs later, the UE sends an UL data TTI bundle 605 across four TTI (TTI #4 through TTI #7) 607, 609, 611, 613. The eNB can use all four TTI to decode the uplink signal. Based on the CRC, a HARQ feedback message is transmitted four TTI after the last TTI within the bundle, on TTI #11 615. If the UE receives an ACK, the transmission of the TTI bundle is deemed successful. If the UE receives a NACK 617, the transmission of the TTI bundle fails and that triggers a retransmission of the complete bundle of four TTI. A retransmission 619 happens in TTI #15 through TTI #18 621, 623, 625, 627, which is four TTI after the HARQ is received in TTI #11 615. If the repeated UL data TTI bundle is decoded, the eNB sends an ACK 631 in TTI #22 629. The retransmission delay in that case is 16 TTIs when using TTI bundling, compared to 8 TTIs when TTI bundling is deactivated.

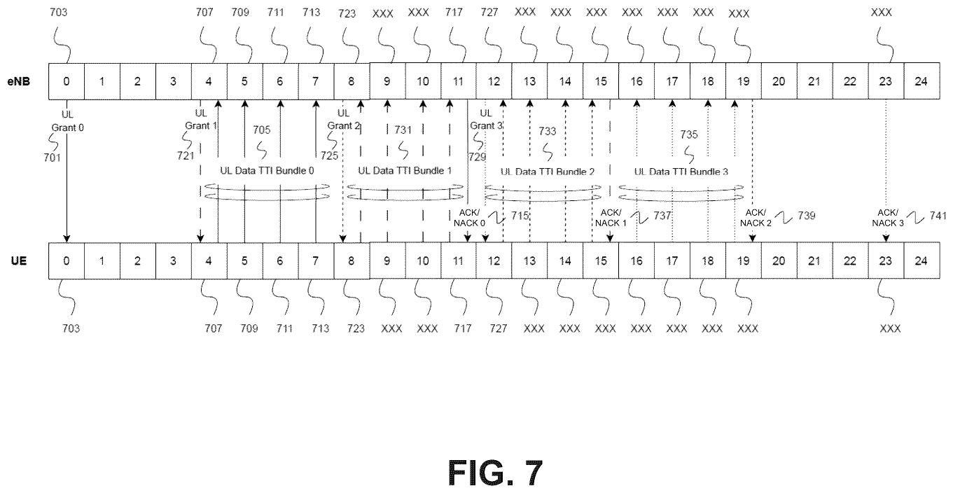

FIG. 7 shows TTI bundling operations in a terrestrial scenario. In the case of FDD, a maximum of four HARQ processes can be active at the same time. Each HARQ process includes an uplink grant transmitted from the eNB to the UE to schedule an uplink transmission. The UE transmits a bundle of four TTIs, which bundle is decoded by the eNB and the eNB responds with HARQ feedback. A total of 12 TTI separates the reception of the uplink grant (DCI 0) from the reception of the first HARQ response compared to 8 TTI when the TTI bundling is deactivated. The process begins with an Uplink Grant 0 701 in TTI #0 703. Four milliseconds later, an Uplink Data TTI bundle 0 705 is sent from the UE to the eNB. Uplink Data TTI bundle 0 705 includes four transmissions, across TTI #4 707, TTI #5 709, TTI #6 711, and TTI #7 713. Four TTIs after the last Uplink Data TTI bundle transmission (in TTI #7 713), the eNB sends a HARQ response (ACK/NACK 0 715) in TTI #11 717. The four HARQ processes start and stop in a cascading manner, where process 0 starts in TTI #0 703 with UL Grant 0 701, process 1 starts 4 ms later in TTI #4 707 with a UL Grant 1 721; process 2 starts 4 ms after that in TTI #8 723 with a UL Grant 2 725, and finally process 3 starts 4 ms after that in TTI #12 727 with a UL Grant 3 729. Uplink Grant downlinks have corresponding Uplink Data TTI bundles that begin 4 ms after the uplink grant downlinks, and last for four TTI. UL Grant 1 721 triggers Uplink Data TTI bundle 1 731, UL Grant 2 725 triggers Uplink Data TTI bundle 2 733, and UL Grant 3 729 triggers Uplink Data TTI bundle 3 735. Each Uplink Data TTI bundle has corresponding HARQ feedback: ACK/NACK 0 715, ACK/NACK 1 737, ACK/NACK 2 739, and ACK/NACK 3 741.

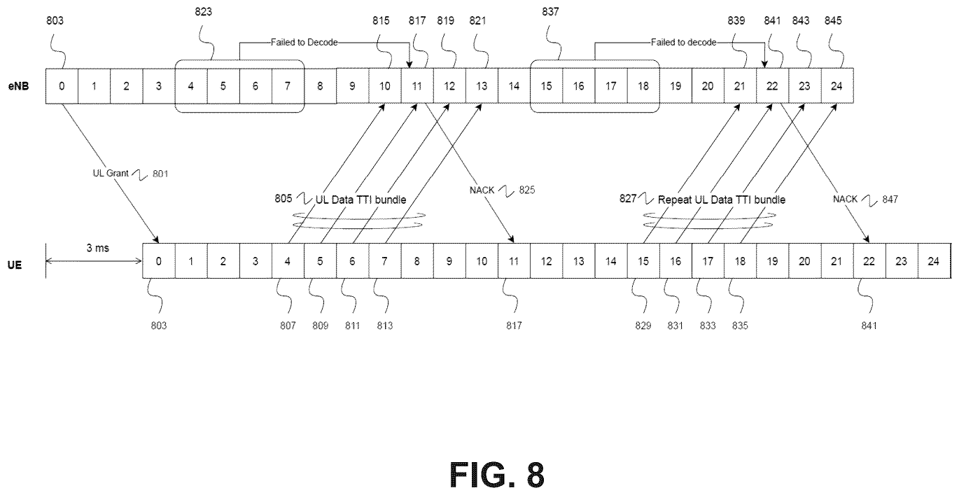

FIG. 8 shows how TTI bundling can fail to operate over a long propagation delay, which in this example is 3 ms one-way propagation (6 ms round-trip). The eNB sends to the UE an uplink grant (DCI 0) 801 in TTI #0 803 to schedule resources for UL TTI bundling transmission. The UE sends four transmissions in a UL Data TTI bundle 805 starting in TTI #4 807 and ending in TTI #7 813. These transmissions are received at the eNB in TTI #10 815, TTI #11 817, TTI #12 819, and TTI #13 821. The eNB is expecting the bundle of four TTI to arrive in TTI #4-#7 823, so when the eNB fails to decode the uplink signal, it schedules a HARQ with a NACK 825 on TTI #11 817. The UE receives a NACK 825 on TTI #11 817, and in response the UE sends a repeat 827 of the bundle of four transmissions on TTI #15 829 through TTI #18 835, which are received on the eNB on TTI #21 839 through TTI #24 845. The eNB is expecting the bundle of four TTI to arrive in TTI #15-#18 837, so when the eNB fails again to decode the uplink signal, it schedules a HARQ with a NACK 847 in TTI #22 841. The UE will respond by repeating the same TTI bundling until it reaches the maximum retransmission setting configured by the eNB. The propagation delay introduces a shift between the TTI reference frame of the eNB and the UE, which prevents the TTI bundling protocol from ever closing the feedback loop in time when subject to extensive delays.

It is worth noting that even with a shorter delay, for example, 1 ms one-way propagation (2 ms round-trip), the TTI bundling protocol will still fail even if the uplink signal arrives partially inside the TTI bundle window on the eNB. Each TTI inside the TTI bundle is coded with a different Redundancy Version (RV) which prevents the eNB from decoding an uplink signal arriving in a different TTI than expected. For example, if an eNB is scheduled to receive a TTI bundle on TTI #4 through TTI #7, but receives the TTI bundle on TTI #6 through TTI #9, even if the uplink signal is partially inside the TTI bundle window (TTI #6 and TTI #7), the uplink signal will not be decoded because the RV corresponding to TTI #6 and TTI #7 only matches with the two last TTIs of the TTI bundle.

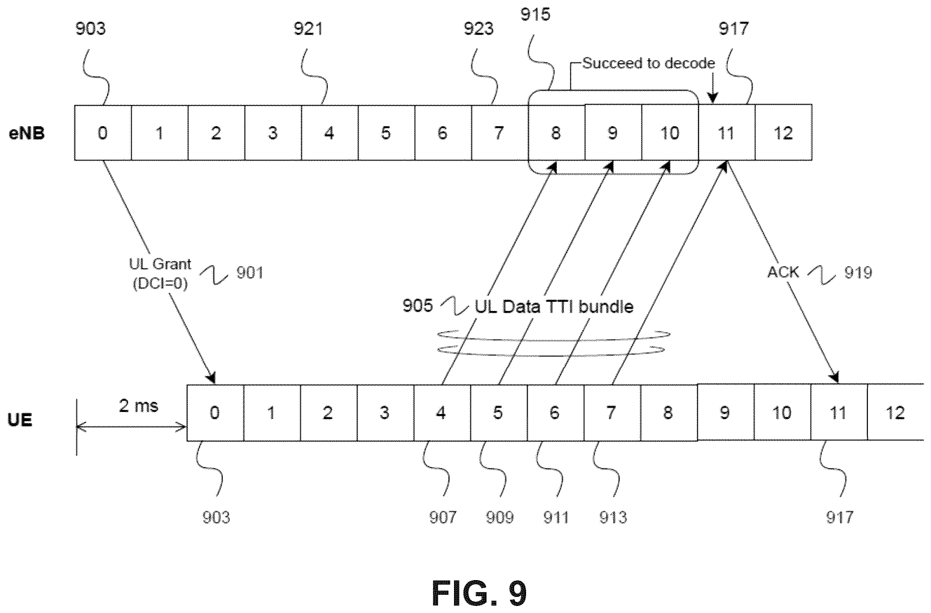

FIG. 9 illustrates an eNB handling a long propagation delay with TTI bundling. In this example, the delay is fixed to 2 ms one-way (4 ms round-trip) but this description is applicable to other delays. The eNB sends to the UE an uplink grant (DCI 0) 901 on TTI #0 903 to schedule resources for transmission of a UL Data TTI bundle 905. UL Data TTI bundle 905 is sent on TTI #4 907, TTI #5 909, TTI #6 911, and TTI #7 913. The eNB modifies the timing of the reception of the uplink signal according to the total propagation delay. Instead of scheduling the reception of UL Data TTI bundle 905 on TTI #4 921 through TTI #7 923, the eNB schedules the reception of UL Data TTI bundle 905 to include/anticipate a total delay, which would be TTI #8 through TTI #11. However, in order to HARQ feedback on TTI #11, 917, the eNB only has the benefit of TTI #8-#10 915 in UL Data TTI bundle 905. The eNB uses the three first TTIs of the bundle to decode the uplink signal and communicate the result of the signal processing using a HARQ 919 on the PHICH. If the uplink signal was decoded using the first three TTI, HARQ 919 is an ACK message, sent to the UE on TTI #11 917.

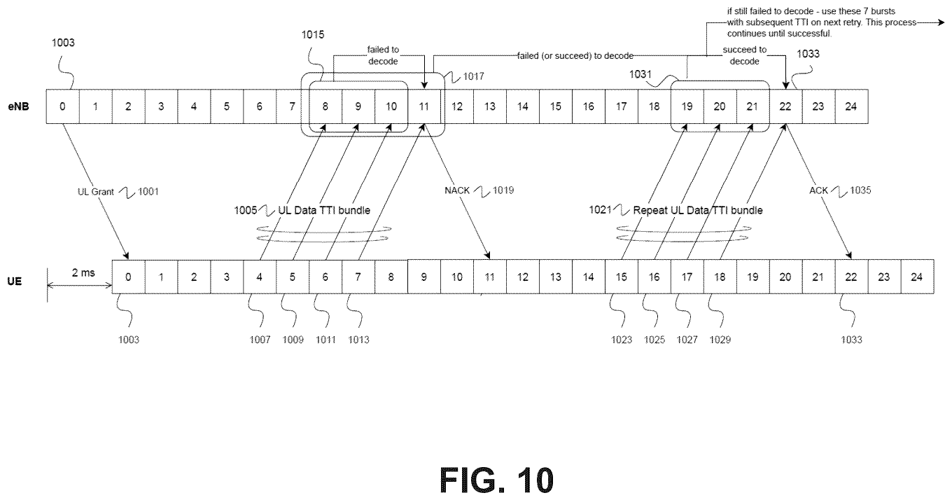

FIG. 10 presents the case where there is a 2 ms one-way delay between the eNB and the UE, but where the eNB fails to decode the three first TTIs of an Uplink Data TTI bundle. As illustrated, the eNB sends an Uplink Grant 1001 on TTI #0 1003. The UE responds with an Uplink Data TTI bundle 1005 on TTI #4 1007 through TTI #7 1013. Uplink Data TTI bundle 1005 arrives at the eNB on TTI #8 through TTI #11. The first three TTIs arrive in a block 1015 comprising TTI #8 through TTI #10, which occurs before the eNB needs to provide HARQ feedback 1019 on TTI #11. As shown in the example of FIG. 10, the eNB does not decode the message based on the first three TTI and sends a NACK as HARQ feedback 1019 to the UE. After sending the NACK, the eNB receives the entire four TTI 1017 of the Uplink Data TTI bundle 1005. So, after sending the NACK, the eNB can attempt to decode the uplink signal using all four TTIs. Even if the whole bundle is not enough to decode the message, it can be used in combination with the first three TTI 1031 of a repeated Uplink Data TTI bundle 1021, which is sent by the UE on TTI #15 1023 through TTI #18 1029. Across these seven TTIs between Uplink Data TTI bundle 1005 and repeated Uplink Data TTI bundle 1021, the signal has a good probability of being successfully decoded. As illustrated in FIG. 10, the eNB successfully decodes after the repeated bundle and sends an ACK 1035 in TTI #22 1033. Even if the eNB cannot decode the message using the seven TTI from 1017 and 1031, the eNB can use these seven TTIs in combination once more with the next three TTI that it receives on a subsequent retry from the UE. This process continues, generally, aggregating received TTI until successful decode. The eNB does not necessarily have to decode the retransmission in repeated Uplink Data TTI bundle 1021 if it already has the ACK scheduled based on decoding the first four TTIs 1017 in the original Uplink Data TTI bundle 1005.

The methods based on blind ACK, blind NACK, and TTI bundling may be adaptively selected in real-time according to the propagation delay and the link quality such as SNR. Table 2 illustrates how an eNB might be programmed to handle different combinations of one-way delay and SNR. When the one-way delay is less than or equal to 3 ms, TTI bundling can be used to avoid retransmissions. When the one-way delay is larger than 3 ms, the blind ACK method might be used to reduce the overhead of redundant uplink retransmissions for a high-SNR environment, and blind NACK might be selected to reduce the latency for a low-SNR environment.

TABLE 2

| One-way Delay | SNR | Method to Use |
|---|---|---|
| Less than or equal to 3 ms | Low | TTI Bundling |
| Larger than 3 ms | Low | Blind NACK |
| Less than or equal to 3 ms | High | TTI Bundling |
| Larger than 3 ms | High | Blind ACK |

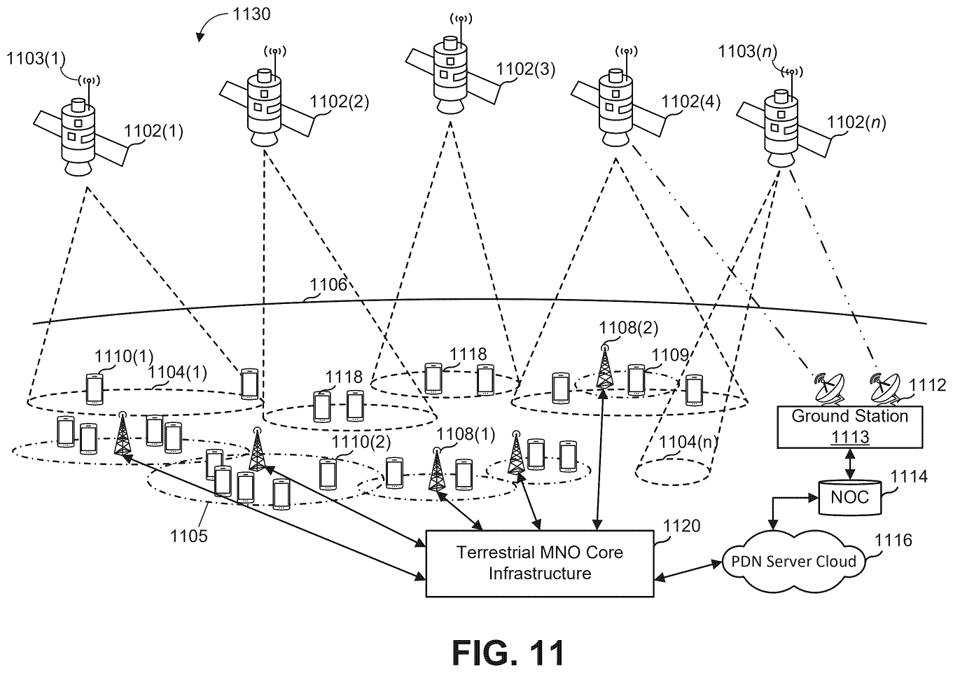

FIG. 11 illustrates a communications environment 1130 wherein UEs communicate with terrestrial base stations and orbital base stations and can do so without requiring reconfiguration of the UEs. Such a communications environment might be where the UEs and eNBs described above operate. For example, satellites 1102(1)-(n) in orbit might communicate as eNBs with terrestrial UEs 1110, 1118, in various footprints 1104, 1105, 1109, as well as with a ground station 1113 having antennae 1112. Ground station 1113 might connect to terrestrial towers 1108 via a Network Operations Center (NOC) 1114, a PDN server cloud 116 and terrestrial mobile network operator (MNO) core infrastructure 1120.

As shown there, a communications environment 1130 might include a constellation of satellites 1102 (e.g., satellite 1102(1), satellite 1102(2), . . . , satellite 1102(n)), where at least one of satellites 1102 includes a non-terrestrial base station (NTBS) 1103. The non-terrestrial base station may include a processor, software stored and/or executing on the processor, and a radio for cellular communication that is programmed according to a protocol recognizable by the ground-based cellular network 1140 and/or UEs 1110, such as cellular handsets. Each satellite 1102 may be capable of communicating with a respective geographic area or footprint, which may or may not contain terminals 1110.

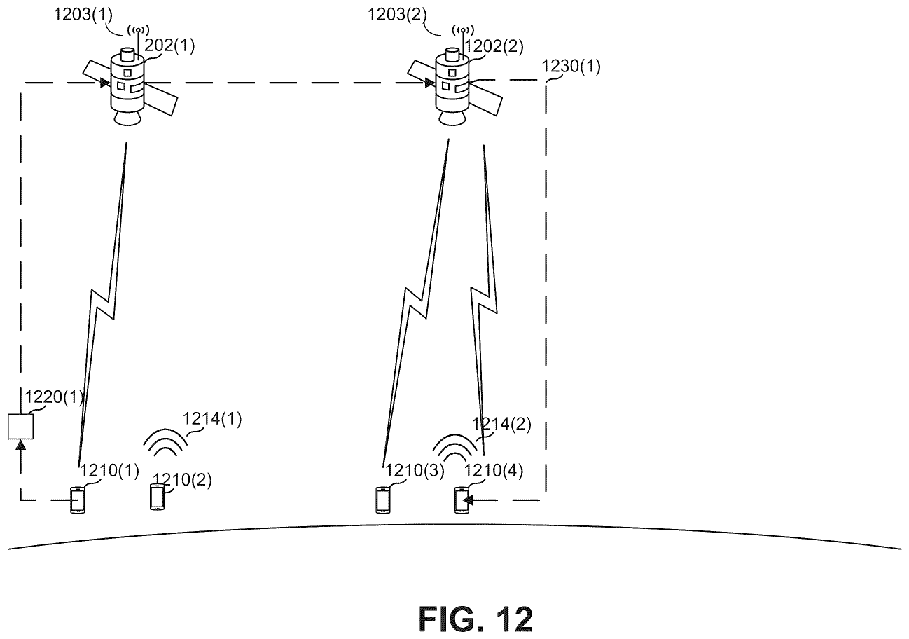

Examples of satellites in FIG. 11 include satellites 1102(1), 1102(2), . . . , 1102(n). As used herein, the use of ellipses and “n” indicates that some number of like elements are present and the exact value of n need not be specified, while the use of “i” and “(i)” might refer to an unspecified one of those n like elements. It should be noted that “n” and “i” might be used as indicators in more than one place and they do not necessarily indicate a one-to-one correspondence across different uses. An example of NTBS 1103 on a satellite includes orbital cellular base station 1103(1) shown in FIG. 11, orbital cellular base station 1203(1) shown in FIG. 12, etc.

FIG. 12 illustrates how messages and data can be conveyed from one UE to another via orbital base stations, in compliance with one or more protocols. As illustrated in FIG. 12, non-terrestrial base stations 1203(1), 1203(2) as might be used as eNBs capable of mobile network operation with multiple air interfaces such as Global System for Mobile Communications (GSM) and Long-Term Evolution (LTE), according to various embodiments. Elements in FIG. 12 named similarly to elements in other figures, such as FIG. 11, might be similarly constructed.

In the example shown in FIG. 12, non-terrestrial base station 1203(1) is located on a satellite 1202(1) and might be capable of communicating directly with a terminal 1210(1), such that a communication link 1214(1) can be established between terminal 1210(1) and a second terminal 1210(2). The terminals might be UEs such as mobile handsets or other wireless devices. Non-terrestrial base station 1203(2) of satellite 1202(2) might be capable of communicating directly with a terminal 1210(3) and a terminal 1210(4), such that a communication link 1214(2) can be established between terminal 1210(3) and terminal 1210(4).

In this way, any terminal can establish a communication link with any other terminal. A message might be passed along a message path from terminal to another terminal. In the example shown in FIG. 12, a message 1220(1) is passed from terminal 1210(1) to terminal 1210(4) along a message path 1230(1) that includes satellite 1202(1) and satellite 1202(2).

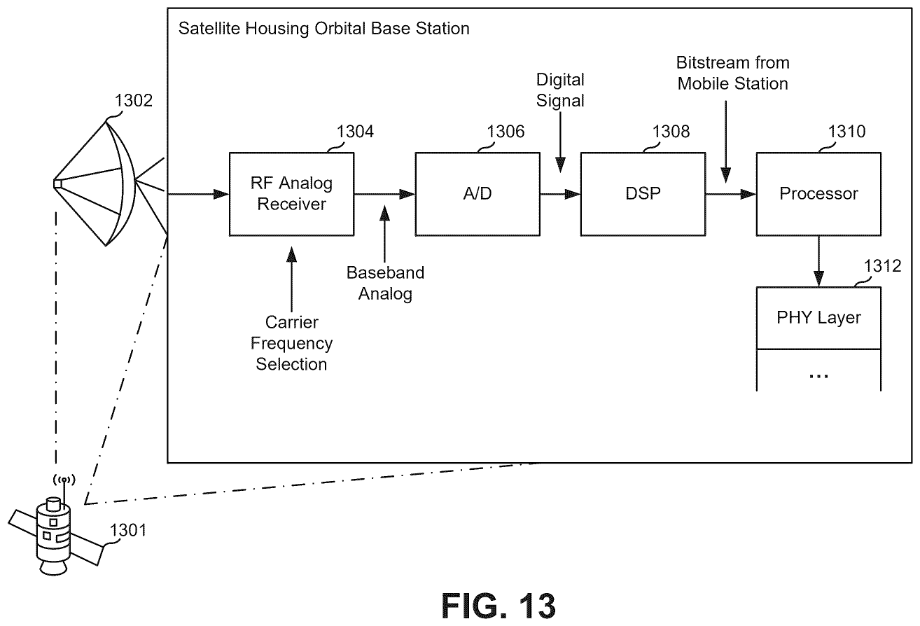

FIG. 13 is a block diagram of some elements that might be present in a satellite housing an orbital base station. FIG. 13 shows communication portions 1300 of a satellite that handles communications according to various embodiments. These communication portions 1300 may, for example, form or be a part of an eNB such as an orbital base station operating as an eNB, as illustrated in FIG. 11 and elsewhere. As shown in FIG. 13, a satellite 1301 houses an eNB. An antenna 1302 receives signals as described elsewhere herein, and/or transmits signals as described elsewhere herein. Antenna 1302 provides an analog signal to an RF analog receiver 1304. A base station controlled might select a carrier frequency and provide a carrier frequency of interest indication to RF analog receiver 1304. There might be more than one of such receivers, one per channel, implemented in hardware and/or software. An output of RF analog receiver 1304 is a baseband analog signal, which is supplied to an analog-to-digital converter (A/D) 1306 to generate a digital signal. The digital signal is processed by a digital signal processor (DSP) 1308 that outputs a bitstream corresponding to a bitstream output by a UE and outputs it to a processor 1310 that can then process the binary code from the bitstream, perhaps in a physical (PHY) network layer 1312 in a conventional manner.

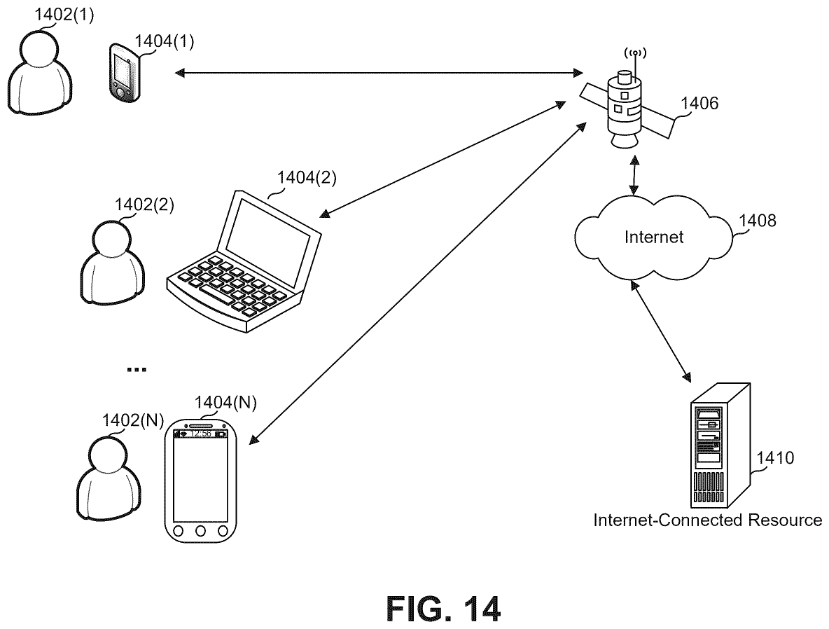

FIG. 14 illustrates how users (e.g., users 1402) using UEs, such as mobile phones, smart devices, computers, etc. (e.g., devices 1404) can connect to network resources via an eNB 1406 to connect to networks such as the Internet 1406 and Internet-connected resources 1410.

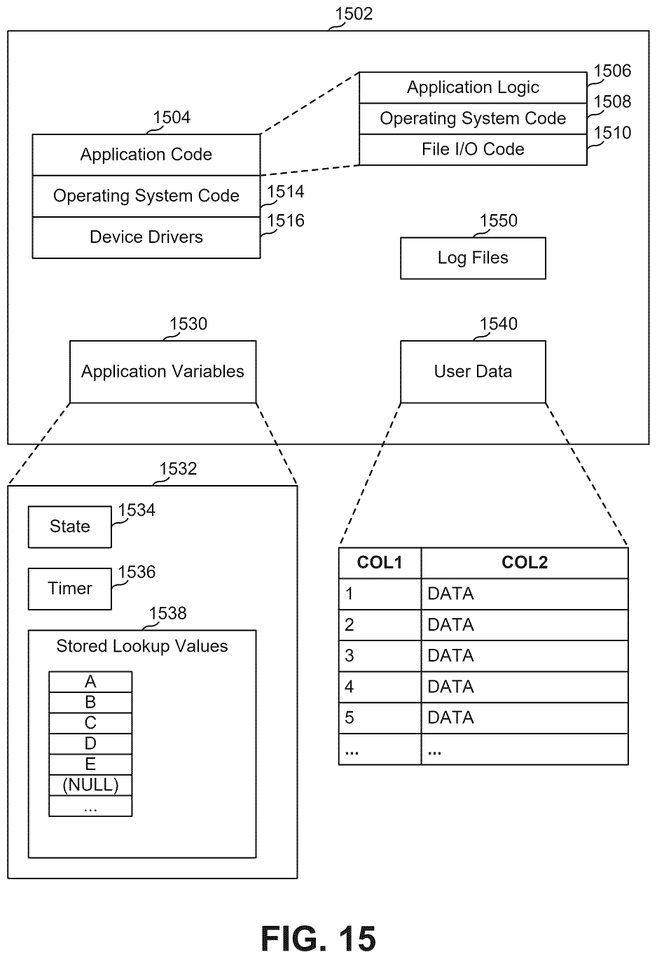

FIG. 15 is a simplified functional block diagram of a storage device 1502 having an application that can be accessed and executed by a processor in a computer system as might be part of embodiments of a communications system and/or a computer system that performs communication operations. FIG. 15 also illustrates an example of memory elements that might be used by a processor to implement elements of the embodiments described herein. In some embodiments, the data structures are used by various components and tools, some of which are described in more detail herein. The data structures and program code used to operate on the data structures may be provided and/or carried by a transitory computer readable medium, e.g., a transmission medium such as in the form of a signal transmitted over a network. For example, where a functional block is referenced, it might be implemented as program code stored in memory. The application can be one or more of the applications described herein, running on servers, clients or other platforms or devices and might represent memory of one of the clients and/or servers illustrated elsewhere.

Storage device 1502 can be one or more memory device that can be accessed by a processor and storage device 1502 can have stored thereon application code 1504 that can be one or more processor readable instructions, in the form of write-only memory and/or writable memory. Application code 1504 can include application logic 1506, library functions 1508, and file I/O functions code 1510 associated with the application. The memory elements of FIG. 15 might be used for a server or computer that interfaces with a user, generates data, and/or manages other aspects of a process described herein. In addition to application code 1504, storage device 1502 might also contain operating system code 1514 and device drivers 1516.

Storage device 1502 can also include storage for application variables 1530 that can include one or more storage locations configured to receive variables 1532. Application variables 1530 can include variables that are generated by the application or otherwise local to the application, such as state variables 1534, timers 1536, and/or stored lookup values 1538. Application variables 1530 can be generated, for example, from data retrieved from an external source, such as a user or an external device or application. A processor can execute application code 1504 to generate application variables 1530 provided to storage device 1502. A processor might be implemented using a general-purpose processing chip, a programmed FPGA, some combination of hardware and firmware, or the like.

Application variables 1530 might include operational details needed to perform the functions described herein.

Storage device 1502 can include storage for databases and other data described herein. One or more memory locations can be configured to store user data 1540, which might include data sourced by an external source, such as a user or an external device. User data 1540 can include, for example, records being passed between servers prior to being transmitted or after being received. Other data might also be supplied.

Storage device 1502 can also include log files 1550 having one or more storage locations configured to store results of the application or inputs provided to the application. For example, log files 1550 can be configured to store a history of actions, alerts, error messages, and the like.

According to some embodiments, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

One embodiment might include a carrier medium carrying data that includes data having been processed by the methods described herein. The carrier medium can comprise any medium suitable for carrying the data, including a storage medium, e.g., solid-state memory, an optical disk or a magnetic disk, or a transient medium, e.g., a signal carrying the data such as a signal transmitted over a network, a digital signal, a radio frequency signal, an acoustic signal, an optical signal or an electrical signal.

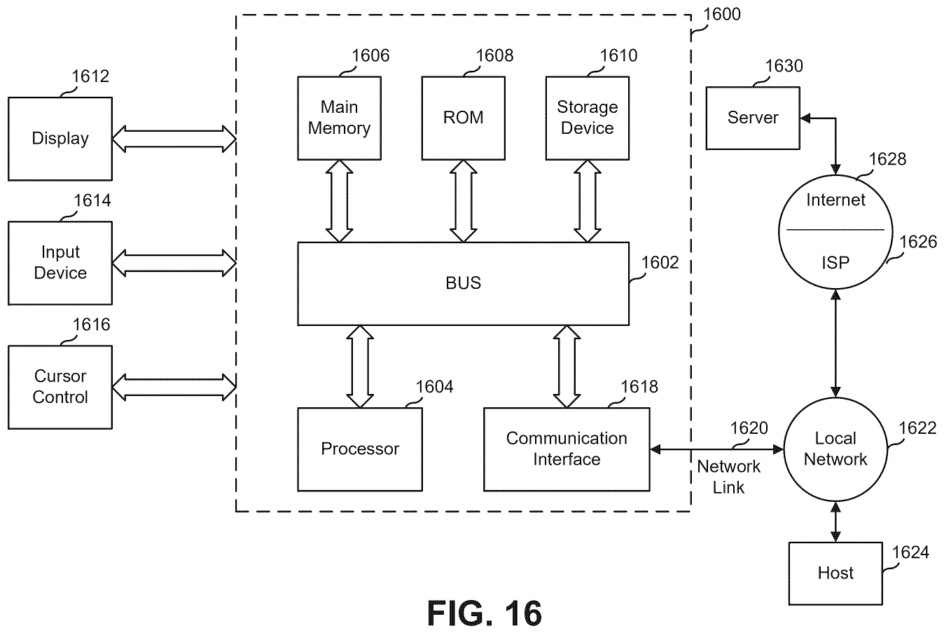

FIG. 16 is a block diagram that illustrates a computer system 1600 upon which the computer systems of the systems described herein and/or data structures shown in FIG. 15 may be implemented. Computer system 1600 includes a bus 1602 or other communication mechanism for communicating information, and a processor 1604 coupled with bus 1602 for processing information. Processor 1604 may be, for example, a general-purpose microprocessor.

Computer system 1600 also includes a main memory 1606, such as a random-access memory (RAM) or other dynamic storage device, coupled to bus 1602 for storing information and instructions to be executed by processor 1604. Main memory 1606 may also be used for storing temporary variables or other intermediate information during execution of instructions to be executed by processor 1604. Such instructions, when stored in non-transitory storage media accessible to processor 1604, render computer system 1600 into a special-purpose machine that is customized to perform the operations specified in the instructions.

Computer system 1600 further includes a read only memory (ROM) 1608 or other static storage device coupled to bus 1602 for storing static information and instructions for processor 1604. A storage device 1610, such as a magnetic disk or optical disk, is provided and coupled to bus 1602 for storing information and instructions.

Computer system 1600 may be coupled via bus 1602 to a display 1612, such as a computer monitor, for displaying information to a computer user. An input device 1614, including alphanumeric and other keys, is coupled to bus 1602 for communicating information and command selections to processor 1604. Another type of user input device is a cursor control 1616, such as a mouse, a trackball, or cursor direction keys for communicating direction information and command selections to processor 1604 and for controlling cursor movement on display 1612. This input device typically has two degrees of freedom in two axes, a first axis (e.g., x) and a second axis (e.g., y), that allows the device to specify positions in a plane.

Computer system 1600 may implement the techniques described herein using customized hard-wired logic, one or more ASICs or FPGAs, firmware and/or program logic which in combination with the computer system causes or programs computer system 1600 to be a special-purpose machine. According to one embodiment, the techniques herein are performed by computer system 1600 in response to processor 1604 executing one or more sequences of one or more instructions contained in main memory 1606. Such instructions may be read into main memory 1606 from another storage medium, such as storage device 1610. Execution of the sequences of instructions contained in main memory 1606 causes processor 1604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as storage device 1610. Volatile media includes dynamic memory, such as main memory 1606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include bus 1602. Transmission media can also take the form of acoustic or light waves, such as those generated during radio-wave and infra-red data communications.

Various forms of media may be involved in carrying one or more sequences of one or more instructions to processor 1604 for execution. For example, the instructions may initially be carried on a magnetic disk or solid-state drive of a remote computer. The remote computer can load the instructions into its dynamic memory and send the instructions over a network connection. A modem or network interface local to computer system 1600 can receive the data. Bus 1602 carries the data to main memory 1606, from which processor 1604 retrieves and executes the instructions. The instructions received by main memory 1606 may optionally be stored on storage device 1610 either before or after execution by processor 1604.

Computer system 1600 also includes a communication interface 1618 coupled to bus 1602. Communication interface 1618 provides a two-way data communication coupling to a network link 1620 that is connected to a local network 1622. For example, communication interface 1618 may be a network card, a modem, a cable modem, or a satellite modem to provide a data communication connection to a corresponding type of telephone line or communications line. Wireless links may also be implemented. In any such implementation, communication interface 1618 sends and receives electrical, electromagnetic, or optical signals that carry digital data streams representing various types of information.

Network link 1620 typically provides data communication through one or more networks to other data devices. For example, network link 1620 may provide a connection through local network 1622 to a host computer 1624 or to data equipment operated by an Internet Service Provider (ISP) 1626. ISP 1626 in turn provides data communication services through the world-wide packet data communication network now commonly referred to as the “Internet” 1628. Local network 1622 and Internet 1628 both use electrical, electromagnetic, or optical signals that carry digital data streams. The signals through the various networks and the signals on network link 1620 and through communication interface 1618, which carry the digital data to and from computer system 1600, are example forms of transmission media.

Computer system 1600 can send messages and receive data, including program code, through the network(s), network link 1620, and communication interface 1618. In the Internet example, a server 1630 might transmit a requested code for an application program through the Internet 1628, ISP 1626, local network 1622, and communication interface 1618. The received code may be executed by processor 1604 as it is received, and/or stored in storage device 1610, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The code may also be provided carried by a transitory computer readable medium e.g., a transmission medium such as in the form of a signal transmitted over a network.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A method of communication over a cellular network connection between a mobile device and a base station, wherein the mobile device and the base station are configured to operate according to a protocol, wherein the protocol has a design assumption of a maximum distance between communicating devices, and wherein the mobile device and the base station are separated by more than the maximum distance, the method comprising:
receiving an uplink data unit at the base station;
decoding the uplink data unit to determine uplinked data;
prior to determining whether the uplinked data is correctly received at the base station, transmitting a feedback acknowledgement message to the mobile device;
determining whether the uplinked data is correctly received at the base station;
if the uplinked data is not correctly received at the base station, recording a need for a retransmission; and
transmitting, from the base station to the mobile device, a feedback message for a subsequent data unit, wherein the feedback message indicates failure of the uplink data unit.

2. The method of claim 1, wherein the feedback message comprises an indication that a future uplink data unit is to be the same as the uplink data unit incorrectly received at the base station.

3. The method of claim 1, wherein the feedback acknowledgement message is a blind feedback acknowledgement message, sent independently of whether the uplink data unit was correctly received.

4. The method of claim 3, wherein the feedback acknowledgement message is sent prior to decoding an uplink message.

5. The method of claim 1, further comprising:
providing a blind negative acknowledgement as initial feedback, to trigger the retransmission;
receiving subsequent uplink data as the retransmission; and
providing a subsequent acknowledgement feedback, as to the uplinked data, in response to the subsequent uplink data, if a combined decoding result of uplink transmissions is received correctly at the base station.

6. The method of claim 5, further comprising:
employing multiple hybrid automatic repeat request (HARQ) processes simultaneously; and
providing acknowledgment based on combined decode result of previously received uplink transmissions.

7. The method of claim 1, further comprising:
providing a blind positive acknowledgment as initial feedback; and
requesting subsequent retransmissions using new uplink grants when the uplink data unit is not successfully decoded at the base station.

8. The method of claim 1, wherein transmitting the feedback acknowledgement message prior to determining whether the uplinked data is correctly received at the base station is performed prior to receiving the uplinked data unit.

9. The method of claim 1, wherein transmitting the feedback acknowledgement message prior to determining whether the uplinked data is correctly received at the base station is performed prior to decoding the uplink data unit.

10. The method of claim 1, further comprising:
enabling transmission time interval (TTI) bundling; and
providing acknowledgement feedback to the mobile device based on partial decode result of a received uplink bundle.

11. The method of claim 1, further comprising:
enabling transmission time interval (TTI) bundling; and
providing acknowledgement feedback to the mobile device following a delay for reception of acknowledgement feedback.

12. The method of claim 1, further comprising providing acknowledgement feedback to the mobile device selected based on propagation delay, link quality, and decoding results of uplink transmissions received previously.

13. The method of claim 1, wherein transmission time interval (TTI) bundling is adaptively selected based on propagation delay, link quality, and decoding results of uplink transmissions received previously.

14. A non-transitory computer-readable storage medium storing instructions, which when executed by at least one processor of a computer system, causes the computer system to:
operate according to a protocol, wherein the protocol has a design assumption of a maximum distance between communicating devices, and wherein a mobile device and a base station are separated by more than the maximum distance;
receive an uplink data unit at the base station;
decode the uplink data unit to determine uplinked data;
prior to determining whether the uplinked data is correctly received at the base station, transmit a feedback acknowledgement message to the mobile device;
determine whether the uplinked data is correctly received at the base station;
if the uplinked data is not correctly received at the base station, record a need for a retransmission; and
transmit, from the base station to the mobile device, a feedback message for a subsequent data unit, wherein the feedback message indicates failure of the uplink data unit.

15. The non-transitory computer-readable storage medium of claim 14, wherein the feedback message comprises an indication that a future uplink data unit is to be the same as the uplink data unit incorrectly received at the base station.

16. The non-transitory computer-readable storage medium of claim 14, wherein the feedback acknowledgement message is a blind feedback acknowledgement message, sent independently of whether the uplink data unit was correctly received, wherein the feedback acknowledgement message is sent prior to decoding an uplink message.

17. The non-transitory computer-readable storage medium of claim 14, the instructions further comprising instructions to:
provide a blind negative acknowledgement as initial feedback, to trigger the retransmission;
receive subsequent uplink data as the retransmission;
provide a subsequent acknowledgement feedback, as to the uplinked data, in response to the subsequent uplink data, if a combined decoding result of uplink transmissions is received correctly at the base station;
employ multiple hybrid automatic repeat request (HARQ) processes simultaneously; and
provide acknowledgment based on combined decode result of previously received uplink transmissions.

18. The non-transitory computer-readable storage medium of claim 14, the instructions further comprising instructions to:
transmit the feedback acknowledgement message (1) prior to determining whether the uplinked data is correctly received at the base station is performed prior to receiving the uplinked data unit, and (2) prior to determining whether the uplinked data is correctly received at the base station is performed prior to decoding the uplink data unit.

19. The non-transitory computer-readable storage medium of claim 14, the instructions further comprising instructions to provide acknowledgement feedback to the mobile device selected based on propagation delay, link quality, and decoding results of uplink transmissions received previously.

20. The non-transitory computer-readable storage medium of claim 14, wherein transmission time interval (TTI) bundling is adaptively selected based on propagation delay, link quality, and decoding results of uplink transmissions received previously.
